(19) United States
(12) Patent Application Publication
(10) Pub. No.: US 2020/0271361 A1
(43) Pub. Date: Aug. 27, 2020

(54) COMBINED-TYPE CASCADE REFRIGERATING APPARATUS

(71) Applicant: N. A. M. TECHNOLOGY LTD., MAALOT (IL)

(72) Inventor: ANDREY DOBKIN, MAALOT (IL)

(21) Appl. No.: 16/649,369

(22) PCT Filed: Dec. 27, 2017
(86) PCT No.: PCT/IL2017/051383

§ 371 Date: Mar. 20, 2020

(30) Foreign Application Priority Data
Sep. 24, 2017 (IL) 254616

(51) Int. Cl. F25B 25/02

(52) U.S. Cl. CPC F25B 25/02

(57) ABSTRACT

There is disclosed a combined-type cascade refrigerating apparatus that comprises a compression refrigerating apparatus having a refrigerating circuit and a sorption refrigerating apparatus having an evaporator. The refrigerating circuit is coupled with the evaporator so as to increase the efficiency of a refrigerating circuit.

### FIELD OF THE SUBJECT MATTER

The disclosed subject matter relates to a refrigerating apparatus and processes; in particular, to the use of low-grade heat for optimal refrigerating performance of the refrigerating apparatus. The disclosed subject matter is intended for use within, or as an integral part of refrigerating equipment, including mobile refrigerators, as example, mounted on sea or river vessels, in the sectors of retail, public catering, food and diary production.

### PRIOR ART

There is knowledge of various designs and configurations of a cascade refrigerating apparatus. A frequently utilized cascade apparatus consists of two single-circuit refrigerating apparatuses, wherein each apparatus comprises a compressor, evaporator, condenser, expansion valve and heat-exchangers. Furthermore, there is knowledge of a cascade apparatus, wherein the top cascade represents a two-circuit refrigerating apparatus. Therein, different refrigerants power each cascade. There exist heat pumps, which can function in cascade cycles with various refrigerants. As an example, U.S. Pat. No. 4,149,389 [Hayes et al.] discloses a heat pump that can operate as a cascade refrigerating apparatus.

U.S. Pat. No. 5,729,993 [Boiarski et al.] discloses an embodiment of an air-precooling-type apparatus, wherein air is used as a heat carrier. The primary circuit includes primary compressor, a condenser, evaporator and triple-stream heat exchanger. The auxiliary circuit employs auxiliary compressor, condenser and evaporator that is connected to the triple-stream heat exchanger. Thereby, with the two circuits and the triple-stream heat-exchanger as a common module, the disclosed apparatus can be classified as a cascade refrigerating apparatus.

The use of two or more electric drive compressors is usual within the existing cascade refrigerating apparatuses. Low-temperature cascade refrigerating apparatuses operate with the input electric power that is 30-40% higher than the output refrigerating one. The simplest way of reducing electricity consumption in cascade apparatuses is, as example, by designing the top-cascade as an absorber-type refrigerating apparatus, driven by the disposed low-grade heat. Hence, electricity consumption can be brought down by 50% for the output cold of minus 35° C. and lower.

U.S. Pat. No. 3,824,804 [Sandmark] suggests an example of a combined-type cycle. In its core, it is a cascade refrigerating apparatus of two closed circuits. One circuit consists of a compressor, condenser, expansion valve and evaporator. The other integrates a generator, condenser, evaporator and absorber. Herewith, the triple-mode valve is a common module. It is mounted between the evaporator of the compression circuit and the evaporator of the absorption circuit. Furthermore, Sandmark discloses that mortar in the generator is heated by hot vapor that in turn is generated by the compressor of the first refrigerating circuit. The main shortcoming of this apparatus is that it is impossible to get mortar heat from the vapor of the refrigerant. It is only possible to reduce the temperature of the super-heated refrigerant gas for condensation to take place in the condenser of the compression circuit. For this outcome, the generator has to have either the largest possible surface of heat-exchange or a very low consumption of mortar in the absorption circuit.

U.S. Pat. No. 4,869,069 [Scherer] discloses a refrigerating apparatus comprising both a compression and absorption circuits. The absorption circuit comprises an engine or a prime mover/electric generator combination. The driver thereof supplies the generator of the absorption circuit with heat energy, and the electric drive of the refrigerating circuit with electric energy. This way of coupling of a refrigerating compressor with an absorption circuit does not allow classifying the above refrigerating apparatus as a cascade one. On the other hand, it may well be classified as a hybrid apparatus, wherein the compressor supplies the refrigerant vapor to the condenser or the medium heat-exchanger. This patent disclosure contains some serious errors, which may result in malfunction of the apparatus.

Finally, there is knowledge of other designs of cascade refrigerating apparatuses and heat pumps, disclosed in the list of patents below:
U.S. Pat. No. 2,204,394 Bailey;
U.S. Pat. No. 2,717,765 Lawer et al.;
U.S. Pat. No. 3,392,541 Nussbaum et al.;
U.S. Pat. No. 3,824,804 Sandmark;
U.S. Pat. No. 3,852,974 Brown;
U.S. Pat. No. 4,031,712 Costello et al.;
U.S. Pat. No. 4,149,389 Hayes et al.;
U.S. Pat. No. 4,391,104 Wendschlag;
U.S. Pat. No. 4,484,449 Muench;
U.S. Pat. No. 4,869,069 Scherer;
U.S. Pat. No. 5,729,993 Boiarski et al.;
U.S. Pat. No. 6,609,390 Ueno et al.;
U.S. Pat. No. 6,986,262 Takasugi et al.;
U.S. Pat. No. 8,631,660 Pemmi et al.;
U.S. Pat. No. 8,844,308 Martin et al.;
KR Patent 20030071607 Won et al.;
CN Patent 201666687 Zhou et al.;
CN Patent 202393074 Mei et al.;
CN Patent 203364496 Cuizhen et al.;
RU Patent 2047058 Bukachevich et al.

### Non-Patent Literature

Piotr Cyklis, Ryszard Kantor, Concept of ecological hybrid compression-sorption refrigerating systems. Technical Transactions, Politechniki Krakowskiej; 1-M/2012, issue-5, Year-109, pp. 31-40.
Refrigerating apparatuses, A. Baronenko, N. Bukharin, V. Pekarev, I. Sakun, L. Timopheevski: Edited by L. Timopheevski-Saint-Petersburg, Politechnika, 1997-992p.-pp. 84-90, FIG. 3.5

None of the mentioned apparatuses is efficient enough in terms of energy transformation due to the use of an evaporator-condenser in their embodiments. For an evaporator-condenser to function efficiently it is required that the power of the first cascade circuit be kept quite high, and furthermore, the range of temperatures of the refrigerant be limited.

Moreover, the above cascade refrigerating apparatuses of serially connected operational modules are characterized by unstable functioning. Fault of any element of the embodiment results in serious malfunction of the refrigerating apparatus. Sorption-type apparatuses are difficult to adjust, especially on site. Sorption-type apparatuses, driven by a solid sorbent (adsorbent), are characterized by broad temperature ranges. However, stabilizing possible temperature variations by means of any special devices, as example, receivers is quite complicated. This technological feature affects operation of the entire cascade and limits its embodiment within the sectors, which do not impose strict requirements on temperature regimes.

Absorption-type (liquid-sorbent-type) apparatuses boast better technological capabilities than the adsorption-type (solid-sorbent) ones. At the same time, they require sophisticated control systems, additional pumps for working substance circulation, mounting of rectifying units, and thereby, are characterized by low coefficient of heat. The latter is the reason of a reduced efficiency of an absorption-type apparatus when thereof is embodied as a first-circuit of a cascade apparatus, which is characterized by higher power consumption.

The major shortcomings of the hybrid refrigerating apparatuses, wherein a compressor is included into the circuit of the sorption-type apparatus for the reason of higher efficiency of the power cycle, are increased consumption of electricity and complicated embodiments. These shortcomings seriously diminish the practicability of low-grade (exhaust) heat application. The hybrid apparatuses are driven by a single-type irreplaceable refrigerant, as compared to the cascade ones, which operate with various types of refrigerants. This feature brings power efficiency further down, and overcomplicates the system of electricity consumption control.

### SUMMARY

It is therefore provided in accordance with some exemplary embodiments, a combined-type cascade refrigerating apparatus comprising
a compression refrigerating apparatus having a refrigerating circuit; and
a sorption refrigerating apparatus having an evaporator; wherein the refrigerating
circuit is coupled with the evaporator.

In accordance with another embodiment of the present subject matter, solid sorbent (adsorber) is used in the sorption refrigerating apparatus.

In accordance with another embodiment of the present subject matter, a liquid sorbent (absorber) is used in the sorption refrigerating apparatus.

In accordance with another embodiment of the present subject matter, refrigerants such as water are selected for positive temperatures and methanol, ethylene glycol, or ammonia for negative temperatures.

In accordance with another embodiment of the present subject matter, the evaporator is used as a subcooler.

In accordance with another embodiment of the present subject matter, the cascade refrigerating apparatus further provided with a medium heat-carrier connected between the evaporator and the refrigerating circuit.

In accordance with another embodiment of the present subject matter, the refrigerating circuit is connected to the medium heat-carrier via a receiver to ensure stable temperatures.

In accordance with another embodiment of the present subject matter, the sorption refrigerating apparatus is supplied with low-grade heat via an open circuit.

In accordance with another embodiment of the present subject matter, the sorption refrigerating apparatus is supplied with low-grade heat via a closed circuit with a medium hot heat-carrier.

In accordance with another embodiment of the present subject matter, the receiver is used to stabilize the input temperature.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

FIG. 1 depicts a refrigerating circuit of a compression apparatus coupled in cascade directly with an evaporator of a sorption apparatus, in accordance with preferred embodiment of the disclosed subject matter.

FIG. 2 depicts a refrigerating circuit of a compression apparatus coupled in cascade with an evaporator of a sorption apparatus by means of a medium heat-carrier, in accordance with preferred embodiment of the disclosed subject matter.

FIG. 3 depicts a refrigerating circuit of a compression apparatus coupled in cascade with an evaporator of a sorption apparatus by means of a medium heat-carrier via a receiver used for temperature stabilization, in accordance with preferred embodiment of the disclosed subject matter.

FIG. 4 depicts a sorption-type apparatus coupled with a hot heat-carrier by means of an open circuit, in accordance with preferred embodiment of the disclosed subject matter.

FIG. 5 illustrates a sorption-type apparatus coupled with a hot source of heat by means of a medium heat-carrier, in accordance with preferred embodiment of the disclosed subject matter.

FIG. 6 depicts a sorption-type apparatus coupled with a hot source of heat by means of a medium heat-carrier via a receiver used for temperature stabilization, in accordance with preferred embodiment of the disclosed subject matter.

FIG. 7 presents a thermodynamic diagram of a refrigerating circuit both with and without a subcooler, in accordance with preferred embodiment of the disclosed subject matter, for comparison reasons.

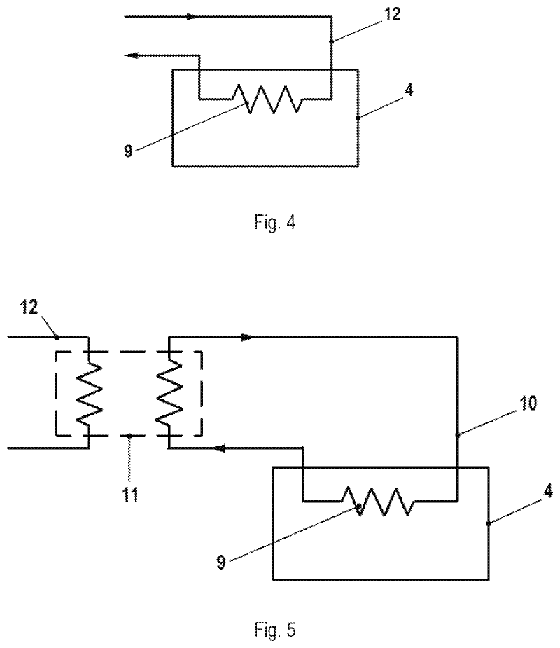

For convenience of demonstration FIGS. 4, 5, 6 do not depict circulating pumps.

### DESCRIPTION OF THE SUBJECT MATTER

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Before explaining at least one embodiment in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting. In discussion of the various figures described herein below, like numbers refer to like parts. The drawings are generally not to scale.

An objective of the disclosed subject matter is to increase the efficiency of a refrigerating circuit of the frequently utilized compression-type refrigerating apparatuses by adding a sorption-type refrigerating apparatus into the existing circuit in the capacity of a subcooler.

The technical hypothesis herewith is that power efficiency of the entire cascade refrigerating apparatus can be increased should the top circuit of the cascade, representing a sorption-type apparatus, used to transform low-grade heat of an ambient utility into cold, be connected to the subcooler of the compression apparatus.

In order to practice the disclosed refrigerating apparatus, a subcooler, which is not an evaporator-condenser, is the common module of the combined-type cascade refrigerating apparatus. The subcooler comprises a sorption-type refrigerating apparatus in its top circuit and a vapor compression refrigerating apparatus in its lower circuit. Thereby, the sorption-type refrigerating apparatus is connected to the subcooler of the vapor compression refrigerating apparatus, rather than to its condenser. This embodiment provides a number of advantages over the existing embodiments. First, the refrigerating power of the sorption-type apparatus can be much lower than the one of the vapor compression apparatus. The top circuit of the existing embodiments is normally connected to a condenser, wherein the power of the top-circuit surpasses the power of the lower circuit, which in turn due to the low heat coefficient requires considerable amount of thermal energy. This approach utilizes even the smallest utilities of low-grade heat, and therefore, broadens noticeably the field of application of the disclosed subject matter. Furthermore, the disclosed embodiments do not require rigorous temperature control, and thereby come with a simplified automation system. Moreover, there is no need to produce a special-type of evaporator-condenser, which is an integral part of the existing cascade refrigerating apparatuses. Hence, the sorption-type apparatus can easily be integrated into the existing refrigerating systems, and meet well lowered financial expenditures and limited deadlines. The reliability of the entire system is significantly high, since the fault of the sorption-type apparatus is no longer critical, and does not affect operation of the vapor compression apparatus.

In accordance with other embodiments of the disclosed subject matter, the sorption apparatus can be supplied with both a solid-body sorbent (adsorber) and a liquid sorbent (absorber). Furthermore, the refrigerants herein can be represented by substances, which are normally utilized under negative temperatures. This approach allows optimization of the present embodiments for each circumstance of use, and provide higher power efficiency.

It is important to state herewith, that there are two major alternative embodiments:

the evaporator of the sorption-type apparatus is used as a subcooler (evaporator-subcooler) per se or;

the evaporator of the sorption-type apparatus is connected to the subcooler by a medium heat-carrier, for example, by water for positive temperatures and ethylene glycol mortar for negative temperatures.

Heat exchange is most efficient within the first alternative. Therefore, this embodiment is possible with any sorption-type apparatus, where the evaporator represents a standalone unit. Should the sorption-type apparatus have no direct evaporator outlet (as example, some adsorption-type apparatuses of two independent modules, which work in turns), then a medium heat-carrier can be used.

Optionally and alternatively, in order to achieve more stable temperatures in the subcooler and thereby provide stable temperature regime, the circuit of the medium heat-carrier is connected via a receiver. This fact is especially important when adsorption-type apparatuses are part of the embodiment. Other embodiments of the disclosed subject matter of practical value include the following:

when low-grade heat is supplied into the sorption-type apparatus via an open circuit; or

when the heat is supplied via a closed circuit, but with a medium hot heat-carrier.

The first alternative above is more effective from the heat-transfer point of view, especially when non-aggressive low-grade heat sources are used, as example, vapor or hot low-grade water. The second alternative is advisable for higher temperatures of low-grade heat sources, when control of the input temperature is essential. The second embodiment allows lowering the requirements for the heat source aggressively indexes.

A receiver can be used to stabilize temperature at the inlet of the sorption-type apparatus. This design is important when both the consumption and thermodynamic indexes of the heat utility are unstable.

A sorption-type refrigerating apparatus transforms low-grade heat into cold with minimum electricity consumption; thereby it increases the efficiency of the entire apparatus.

The above application of the sorption-type apparatus does not increase the risk of a system fault. No malfunction affects operation of the compressor refrigerating apparatus. It keeps on working, although with lesser efficiency, compared to any frequently utilized cascade apparatus, which in that case comes to a standstill. Depending on the field of application, a sorption-type apparatus can be of two types: with liquid sorbent (absorber) and with solid sorbent (adsorber), wherein the refrigerant is either water, used to receive positive temperatures, or spirits, as example methanol or ammonia, used to receive negative temperatures (See Patent PCT/IL2017/050190).

Furthermore, the design of the sorption-type apparatus as a subcooler allows applying apparatuses of lower refrigerating power than the compression-type apparatus. This fact explains the possibility of utilizing even smaller amounts of low-grade heat, and therefore, broadens the area of application of the present subject matter. The aforementioned does not exclude the use of sorption-type apparatuses of higher power capacity.

Another advantage of the sorption-type apparatus is its simple integration capability into the existing refrigerating systems. This can be performed by adding a single heat-exchanger to the present embodiment, as an example. Hence, the existing systems can easily be updated, and their power capacity can be increased.

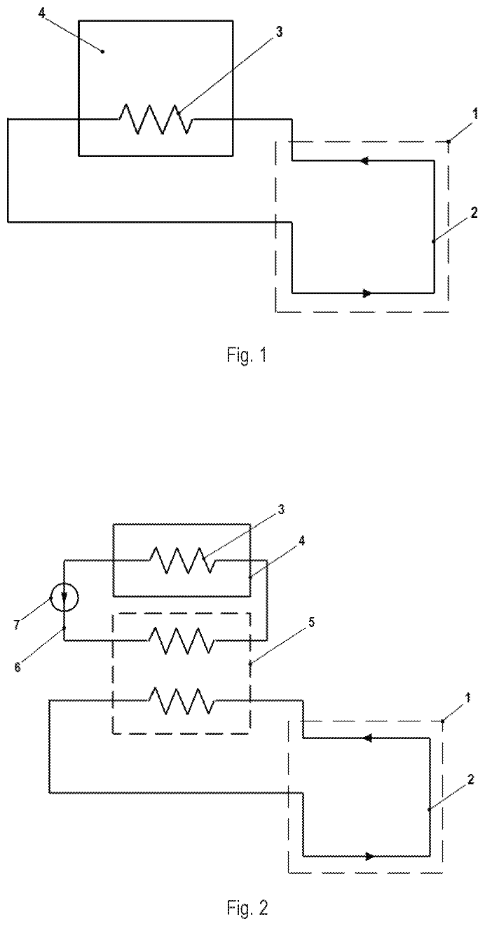

Reference is now made to FIG. 1 illustrating a refrigerating circuit of a compression apparatus coupled in cascade directly with an evaporator of a sorption apparatus, in accordance with preferred embodiment of the disclosed subject matter. According to disclosed subject matter, a combined-type cascade refrigerating apparatus is provided, wherein a sorption-type apparatus is used as a subcooler. This presentation depicts an embodiment that comprises a compression refrigerating apparatus 1 with a refrigerating circuit 2 as known in the art, coupled in cascade directly with an evaporator 3 of a sorption refrigerating apparatus 4. This embodiment was found to be most effective from the heat transfer point of view. It can be used within all types of sorption apparatuses, wherein the evaporator 3 is a standalone unit. The disclosed embodiment can be used within both positive and negative temperatures.

Reference is now made to FIG. 2 depicting a refrigerating circuit of a compression apparatus coupled in cascade with an evaporator of a sorption apparatus by means of a medium heat-carrier, in accordance with preferred embodiment of the disclosed subject matter. Refrigerating circuit 2 of the compression refrigerating apparatus is coupled in cascade with the evaporator 3 of a sorption-type apparatus 4 by means of a medium heat-carrier 6 discharged via a heat-exchanger 5 with help of a circulating pump 7. The disclosed embodiment can be used for sorption-type apparatuses that have no immediate evaporator outlet (as example, some adsorption-type apparatuses of two modules that operate in turn). Herein, water is suggested to be used as a medium heat-exchanger 6 within positive temperatures, and ethylene glycol mortar—within negative temperatures.

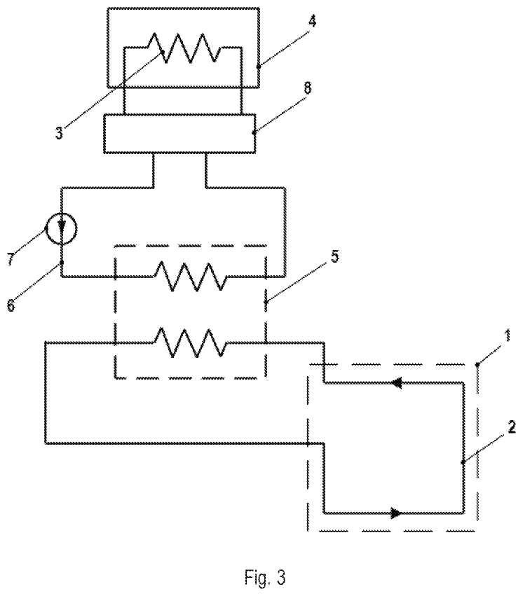

Reference is now made to FIG. 3 illustrating a refrigerating circuit of a compression apparatus coupled in cascade with an evaporator of a sorption apparatus by means of a medium heat-carrier via a receiver used for temperature stabilization, in accordance with preferred embodiment of the disclosed subject matter. The refrigerating circuit 2 of a compression apparatus 1 is coupled in cascade with the evaporator 3 of a sorption-type apparatus 4 by means of a medium heat-carrier 6 that is discharged through a heat-exchanger 5 with help of a circulating pump 7. A receiver 8 is included in the circuit of the medium heat-carrier 6 to ensure stable temperature regime. This design is intended for sorption apparatuses that have no immediate evaporator outlet (as example, like some adsorption-type apparatuses of two modules, which operate in turn). Herein water is suggested to be used as the medium heat-exchanger 6 within positive temperatures, and ethylene glycol mortar within negative temperatures.

Reference is now made to FIG. 4 depicting a sorption-type apparatus coupled with a hot heat-carrier by means of an open circuit, in accordance with preferred embodiment of the disclosed subject matter. Sorption-type apparatus 4 is coupled with an ambient utility of heat 12 by means of an open circuit via a heater 9. The disclosed embodiment is most efficient from heat-transfer point of view, especially when non-aggressive low-grade utilities of heat are applied, as example vapor or hot low-grade water.

Reference is now made to FIG. 5 illustrating a sorption-type apparatus coupled with a hot source of heat by means of a medium heat-carrier, in accordance with preferred embodiment of the disclosed subject matter. Sorption-type apparatus 4 is coupled with ambient utility of heat 12 in a closed circuit by means of a medium heat-carrier 10 that is discharged into a heater 9. The discharge of heat into the medium heat-carrier 10 is carried out via a heat-exchanger 11, which is heated by the ambient utility of heat 12. Application of this embodiment allows lowering requirements to the non-aggressivity of the ambient utility of heat 12.

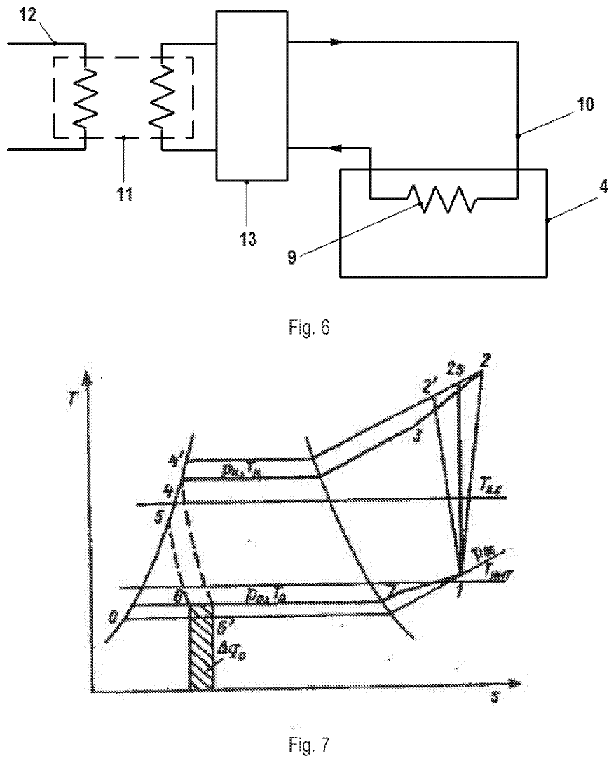

Reference is now made to FIG. 6 depicting a sorption-type apparatus coupled with a hot source of heat by means of a medium heat-carrier via a receiver used for temperature stabilization, in accordance with preferred embodiment of the disclosed subject matter. Sorption-type apparatus 4 is coupled with an ambient utility of heat 12 by means of a medium heat-carrier 10 via a receiver 13, which is used for temperature stabilization. The given embodiment is intended for use under the conditions of both unstable temperatures and unstable consumption of the heating source.

Reference is now made to FIG. 7 presenting a thermodynamic diagram of a refrigerating circuit both with and without a subcooler, in accordance with preferred embodiment of the disclosed subject matter, for comparison reasons. The thermodynamic diagram of a refrigerating cycle of the present subject matter both with and without a subcooler is presented. The hatched area represents increase of the refrigerating efficiency of the apparatus wherein a subcooler is used.

The top module of a combined-type cascade refrigerating apparatus represents a sorption apparatus 4 that transforms the energy of a low-grade heat utility 12 into cold and cools down the refrigerant of the refrigerating circuit 2 of the bottom module, which in turn represents a steam-compressor-type refrigerating apparatus 1 embodied inside the subcooler. The disclosed embodiments allow higher refrigerating power of the steam-compressor-type refrigerating apparatus and minimizes electricity consumption.

Furthermore, the present embodiments allow utilizing energy of all types of sources of low-grade heat, including the smaller ones, which cannot be exploited by the existing apparatuses.

The disclosed embodiments require minimum changes in configuration of the existing refrigerating apparatuses but for the inclusion of a single heat exchanger in the constructions thereof. This fact explains modest expenditures and minimum deadlines expected for modernization of the existing apparatuses.

Simplicity and reliability of the disclosed embodiments guarantee long-time faultless and emergency-shutdown-free operation, even in case of complete failure of the sorption-type apparatus, especially when the apparatus is used as part of mobile aggregates, for example on board of a transport vehicle.

An important feature of the disclosed subject matter is its eco-friendliness. The refrigerants of the sorption-type apparatuses are ozone-friendly. The use of the refrigerants reduces emission of heat into the atmosphere. Furthermore, the reduction of electricity consumption by the entire system also leads to the cut in both heat and carbon dioxide emission within the process of electrical energy generation.

### Practical Application

The disclosed embodiments allow using the sorption-type refrigerating apparatuses as subcoolers within all types of existing and novice refrigerating apparatuses, for the purpose of their 10-20% power efficiency rise (the lower the operational temperature, the higher the power capacity) and increase of refrigerating performance by means of utilizing the potential of low-grade heat energy (including the embodiment with the exhaust).

Water is suggested for use as a refrigerant of the sorption-type apparatus when it is operated within positive temperatures, whereas such antifreeze mortars as spirits (methanol), ammonia, etc. are suggested for use within negative temperatures.

It is suggested that a single sorption-type apparatus is used within the compression refrigerating apparatuses of low and medium power capacity; and modules of several sorption-type apparatuses are used for refrigerating apparatuses of high power capacity.

It is appreciated that certain features of the subject matter, which are, for clarity, described in the context of separate embodiments, may also be provided in combination in a single embodiment. Conversely, various features of the subject matter, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. Combined-type cascade refrigerating apparatus comprising
a compression refrigerating apparatus having a refrigerating circuit; and
a sorption refrigerating apparatus having an evaporator; wherein the refrigerating circuit is coupled with the evaporator.

2. The cascade refrigerating apparatus as claimed in claim 1, wherein solid sorbent (adsorber) is used in the sorption refrigerating apparatus.

3. The cascade refrigerating apparatus as claimed in claim 1, wherein a liquid sorbent (absorber) is used in the sorption refrigerating apparatus.

4. The cascade refrigerating apparatus as claimed in claim 1, wherein refrigerants such as water are selected for positive temperatures and methanol, ethylene glycol, or ammonia for negative temperatures.

5. The cascade refrigerating apparatus as claimed in claim 1, wherein the evaporator is used as a subcooler.

7. The cascade refrigerating apparatus as claimed in claim 1, further provided with a medium heat-carrier connected between the evaporator and the refrigerating circuit.

8. The cascade refrigerating apparatus as claimed in claim 7, wherein the refrigerating circuit is connected to the medium heat-carrier via a receiver to ensure stable temperatures.

9. The cascade refrigerating apparatus as claimed in claim 1, wherein the sorption refrigerating apparatus is supplied with low-grade heat via an open circuit.

10. The cascade refrigerating apparatus as claimed in claim 1, wherein the sorption refrigerating apparatus is supplied with low-grade heat via a closed circuit with a medium hot heat-carrier.

11. The cascade refrigerating apparatus as claimed in claim 8, wherein the receiver is used to stabilize the input temperature.
